(19) United States
(12) Patent Application Publication
(10) Pub. No.: US 2003/0198225 A1
(43) Pub. Date: Oct. 23, 2003

(54) Method for transmitting packets over circuit-switched network

(76) Inventor: Risto Mononen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/436,983

(22) Filed: May 14, 2003

Related U.S. Application Data
(63) Continuation of application No. PCT/FI01/00980, filed on Nov. 12, 2001.

(30) Foreign Application Priority Data
Nov. 14, 2000 (FI) 20002491

(51) Int. Cl. H04L 12/28

(52) U.S. Cl. 370/392

(57) ABSTRACT

The invention relates to a method and packet network for transmitting a packet from a source to a destination on the basis of an IP header in a packet network employing an IP protocol. The packet network comprises a first means arranged to drop at least a part of a destination address included in the IP header to a lower protocol layer to serve as a label. In addition, the packet network comprises a second means arranged to transmit the packet to the destination indicated by the label.

This application is a Continuation of International Application PCT/FI01/00980 filed on Nov. 12, 2001, which designated the U.S. and was published under PCT Article 21(2) in English.

### BACKGROUND OF THE INVENTION

1. Field of the Invention

The invention relates to a method for transmitting a packet from a source to a destination on the basis of an IP header in a packet network employing an IP protocol.

2. Description of the Related Art

In the GPRS network (General Packet Radio System), for example, data is transmitted in data packets. Data transmission networks employ various protocols, such as the TCP/IP (Transmission Control Protocol/Internet Protocol), to form gateways from a mobile phone, for example, to different packet data networks. The packet-switched data transmission referred to means that each packet can be transferred to its destination address on a separate route, regardless of the route on which the previous packet was transferred.

An IP packet to be transmitted comprises a header consisting of a plural number of fields which represent: IP protocol version number (version field); header length (IHL field); service type (Differentiated Services Code Point, DSCP); total packet size (Total Length field); individual identifier (Identification field); fragmentation (Flags field); fragment size (Fragment field); packet lifetime (Time to Live field); payload protocol number (Protocol field); checksum (Header Checksum field); the sender's IP address (Source Address field); the receiver's IP address (Destination field); options (Options field), if any; and the filling of the header (Padding field), if needed.

The header size may be 20 octets, for example, which corresponds to 160 bits. The header fields may be subjected to compression to provide added capacity for the payload. Compression methods are not, however, optimal for use in every environment because the network equipment is not necessarily capable of processing compressed header fields in a desired manner.

In ATM (Asynchronous Transfer Mode) networks data transmission is based on packets of 53 bytes. Each packet contains five bytes reserved for ATM address fields, such as VPI (Virtual Path Identifier) and VCI (Virtual Channel Identifier) header fields. Together these header fields define what is known as a virtual connection, on which data are transmitted. The header fields comprise identifier parameters, the values of which are changed from time to time by means of signalling.

The networks apply different methods for transmitting IP packets from one location to another. One of the methods is routing, in which an IP packet received by an IP router in an OSI (Open System Interconnection) layer three, i.e. a network layer, is first compiled on layer two, possibly from a plural number of frames, and then relayed upward in the protocol stack to layer three. In the network layer, the IP protocol checks the IP address of the packet's receiver and searches a routing table for the next node where the packet is to be transmitted to. IP addresses are globally unambiguous.

In circuit-switched networks, so-called label switching and IP switching can be used to assist in the transfer of IP packets. The switching is carried out directly in layer two of the OSI model such that instead of being compiled of frames of layer two, the received IP packets are forwarded through the layer on the basis of a physical address included in a frame. In a broad sense, the label may be any local channel identifier of a transmitting node.

A problem with packet networks employing label switching is that the switching requires a relatively large amount of configuration and transmission of configuration data. In addition, the networks require a fairly extensive amount of signalling between network elements. The transmission of the above data takes up capacity from the payload.

### SUMMARY OF THE INVENTION

It is therefore an object of the invention to provide a method and equipment implementing the method to allow the above problems to be solved. More precisely, the invention aims at solving problems arising from the large header field size of packet networks and the complex configuration of circuit switching. This is achieved with a method according to the preamble, which is characterized by comprising the steps of dropping at least a part of the IP header to a lower protocol layer and transmitting the packet to the destination on the basis of the dropped part.

The object is also achieved with a method according to the preamble, which is characterized in that the IP header comprises a destination address from which a host part is dropped to a lower protocol layer, a label is formed from the host part of the destination address to label the packet, and the packet is transferred to the destination indicated by the label.

The invention further relates to a packet network applying an IP protocol for transmitting a packet from a source to a destination on the basis of an IP header.

The packet network of the invention is characterized in that the packet network comprises a first means arranged to drop at least a part of a destination address included in the IP header to a lower protocol layer to serve as a label and a second means arranged to transmit the packet to the destination indicated by the label.

In addition, the packet network of the invention is characterized in that the packet network comprises a first means arranged to drop at least a part of the destination address included in the IP header to a lower protocol layer; a third means arranged to form a label from a host part of the destination address for labelling the packet; and a second means arranged to transmit the packet to the destination indicated by the label.

The preferred embodiments of the invention are disclosed in the dependent claims.

An underlying idea of the invention is that a part of the IP destination address is dropped to a lower protocol layer, and a label is formed of the dropped address part to label the packet to be transmitted.

The method and packet network of the invention provide a number of advantages. In the invention, a label is formed of the IP destination address to be used as a destination address in the transfer of packets. The label occupies less space than a full-length IP address, and the saved space can thus be used for other purposes, for example for the transfer of payload. The space needed by the destination address is reduced without additional network configuration or signalling being needed. The invention enables fast transfer of packets.

### BRIEF DESCRIPTION OF THE DRAWINGS

In the following the invention will be described in connection with the preferred embodiments and with reference to the accompanying drawings, in which

FIG. 1 illustrates a first embodiment of a network;

FIG. 2 illustrates a protocol stack at different points of the network;

FIG. 3 illustrates a second embodiment of the network;

FIG. 4 illustrates the network in greater detail.

### DETAILED DESCRIPTION OF THE PREFERRED EMBODIMENT(S)

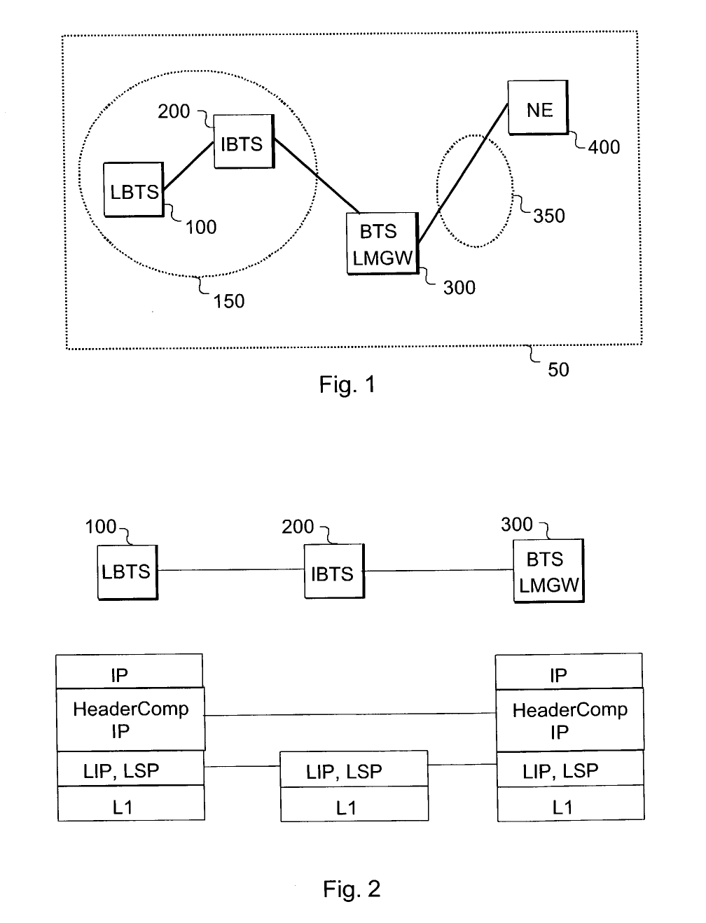

With reference to FIG. 1, a network 50 comprises network elements 100, 200, 300 and 400. In addition, the network comprises a packet network domain 150 in which the data transmission is narrowband and it is carried out using packet switching and circuit switching. Further, the network comprises a network domain 350 in which the data transmission is broadband. As shown in the Figure, the network elements 100, 200 are located in the network domain 150. The Figure also shows that the broadband network domain 350 is between the network element 300 and the network element 400.

The network shown in FIG. 1 may be for example the IPRAN (Internet Protocol Radio Access Network). Data transmission in the broadband domain is based on the use of optical fibres, for example, whereas in the narrowband domain it is based on the use of microwave radios, for example. The invention is not, however, restricted to IPRANs alone, but it may be applied in all IP networks, for example, that meet certain requirements. One of the requirements is that the network must be provided with a specific kind of subnetwork. More precisely, the subnetwork must be provided with CIDR (Classless Interdomain Routing) addresses, for example. One and the same address prefix is used within the area of the subnetwork, the prefix becoming more accurate, i.e. longer, as the process moves downward in the network from a higher network layer to a lower one.

For example, the network element 100 may be an LBTS (Leaf Base Transceiver Station), the network element 200 an IBTS (Intermediate BTS), and the network element 300 an LMGW (Last Mile Gateway) element. From the point of view of data transmission, the network elements serve as so-called node points, which all have a separate IP address. The network elements are capable of carrying out switching in protocol layer two. More precise, they are able to perform it on the basis of a VPI/VCI identifier, for example.

An IP address is composed of a number pair, a first element of the pair comprising a network part and a second element a host part. IP addresses are 32-bit numbers typically represented in the form of decimal numbers separated by dots. This is known as a dotted decimal notation in which each number is represented by the numerical value of one octet, i.e. a group of eight bits, given in a decimal form. For example, an address 131.11.9.3 denotes an IP address in which 131.11 is the network part and 9.3 the host part.

FIG. 2 shows a protocol stack at different points of the network. The layers below each network element LBTS, IBTS and LMGW illustrate the respective protocol structures of the network elements. For example, the protocol stack below the LBTS element comprises an IP layer, a compressed IP layer, an LIP/LPS (Label Switched IP/Label Switched Path) layer and an L1 layer.

The network element 100 and the network element 300 are capable of compressing IP header fields. Compression allows an IP address to be modified to save bandwidth, but, at the same time, the possibility to apply IP routing is lost. For a network element to be able to compress IP header fields, it must appear in a network structure in which a second compressing network element is at a distance of precisely one hop from the first network element. This is required because in a configuration of multiple hops, the network element 200, which is between the network elements 100, 300, is not able to make a routing decision on the basis of a compressed header. The one-hop requirement relating to the network is needed because of the IP layer. To meet the requirement, the network elements performing compression are connected to the same physical transmission path. Another way to meet the requirement is to arrange for the IP layer a ‘view’ of one hop by means of lower layer switching, i.e. a virtual circuit.

The network can be implemented for example such that the compressing network elements are connected to the same physical transmission path. Another way to implement the network is to use lower layer switching, i.e. a virtual connection, to arrange a network configuration of the one-hop type for the IP layer. In practice this means that in a solution according to FIG. 2 the network element 2 cannot make a routing decision on the basis of a compressed IP header, but it switches the packets on the basis of a label produced in a lower layer.

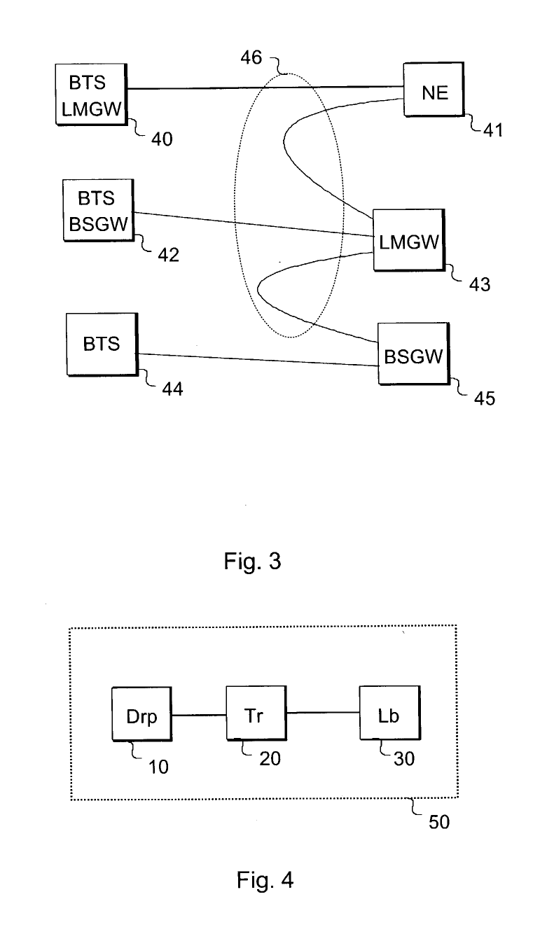

FIG. 3 shows a second embodiment of the network. The network comprises network elements 40, 41, 42, 43, 44, 45 and an IP network part 46. The network elements 40, 43 are LMGW elements and the network elements 42, 45 BSGW elements. More precisely, the network elements 40, 42, 44 are base stations, for example. FIG. 3 shows that the IP network at least partly interconnects the network elements 40 and 41, the network elements 41 and 43, the network elements 42 and 43, the network elements 43 and 45, and the network elements 44 and 45.

The network element 40 is able to carry out LMGW functions also locally, whereas the network element 42 is connected by a transmission path to the remote end network element 43 where LMGW functions can be carried out. The network element 44 is connected to the LMGW element 43 via the BSGW element 45. As shown in the Figure, the IP protocol is not applied on the transmission path interconnecting the network element 44 and the BSGW element 45.

FIG. 4 shows the network 50 in greater detail, the network comprising a first means 10, second means 20 and third means 30. Each of the above mentioned network elements may comprise the means 10, 20, 30. The first means 10 is arranged to drop at least a part of the destination address given in the address field to a protocol layer below the one used by the address field. For example, from a destination address 131.11.10.2 the first means 10 moves the host part 10.2 to a lower protocol layer, i.e. from protocol layer three to protocol layer two.

In practice the dropping of an address part means that lower layer labels are derived from the IP address and therefore lower layer signalling is not needed. The topology information carried by the IP routing can thus be utilized when virtual circuits are formed. The dropping of the address part and compression can be carried out as separate functions or as a single function. However, if IP header overhead and layer two signalling are to be avoided, compression and the dropping of the address part are required. The dropping of the address part supports compression in an IPRAN-type network in particular.

The second means 20 is arranged to use the dropped address to transfer or send the packet to the destination in a subnetwork. In other words, the entire IP address is not needed for transferring the packet in this case. The address field parts dropped to the lower protocol layer by the first means 10 represent the least significant bits. The first means 10 may drop for example 16 least significant bits from the address field to the lower protocol layer. In addition, the second means 20 is arranged to use packet routing information to form virtual circuits in the lower layer for transmitting packets to their destination addresses.

The third means 30 is arranged to form a label from the host part of the destination address, the label being used for labelling the packet before it is forwarded. The label formed by the third means 30 comprises a VPI/VCI identifier. Other possible labels are a PCM/TSL identifier of a TDM switch, MPLS (Multiprotocol Label Switching) router label or the DLCI (Data Link Connection Identifier) field data of a Frame Relay switch. When the packet has been labelled, the second means 20 transfer it to the destination indicated by the label. The functions of the means 10, 20, 30 can in principle be integrated in one and the same means, and they are preferably carried out by software.

The forwarding of IP addresses is based on subnetworking in which all hosts or devices residing in the subnetwork share a common initial address part, whereas the host parts of the subnetwork addresses are different for different devices. Table 1 below depicts a possible address scheme that can be used in the packet network of the invention.

TABLE 1

| Elem. | IP address | IP subnetwork | IP host address |
|---|---|---|---|
| LMGW | 192.168.10.2 | 192.168.0.0/16 | 10.2 |
| IBTS | 192.168.8.4 | 192.168.0.0/16 | 8.4 |
| LBTS | 192.168.9.3 | 192.168.0.0/16 | 9.3 |

Table 1 shows that the subnetwork address consists of 16 most significant bits of a 32-bit IP address. For example, the most significant bits in the subnetwork address of the LMGW element are formed by the address part 131.11. All hosts residing in the same subnetwork share the same subnetwork address. The host address consists of the 16 least significant bits of the address. Within the subnetwork the host address is an individual address and can thus be used as a label in layer 2 switching.

The transfer of an IP packet is based on information about the subnetwork address system, the subnetwork topology and the default routes of the subnetworks. Assume that the default route passes through the LMGW element. The IBTS element in the networks of FIGS. 1 and 2 can then forward the packets according to transfer table 2 below, for example, which is obtained on the basis of the network topology information provided by IP routing.

TABLE 2

| IP destination | | | |
|---|---|---|---|
| address | | next IP address | output gate |
| | 192.168.10.2 | 192.168.10.2 | IBTS → LMGW |
| | 192.168.8.4 | own host | — |
| | 192.168.9.3 | 192.168.9.3 | IBTS → LBTS |
| | other | 192.168.10.2 | IBTS → LMGW |

The transfer table shows that each IP packet with the destination address 192.168.9.3 is transferred from the IBTS element to the LBTS element. The table also shows that IP packets the destination address of which is 192.168.8.4 are not transferred any further from the IBTS element, but they are processed in the IBTS element. Further, the table shows that IP packets having IP addresses different from the above two are forwarded from the IBTS element to the LMGW element.

The packet network may apply ATM technology, for example, in which case IP flow switching takes place on the basis of a separate VPI/VCI identifier, or AMT virtual circuit, determined for the flow and operating on the basis of ATM cell switching. In the method of the invention, the lower level where the address is dropped to forms virtual circuits on the basis of the topology information provided by the IP routing and not on the basis of the ATM signalling, for example. In one embodiment the IBTS element comprises an ATM switch, which may be configured to switch all cells provided with a specific label to the LMGW element without changing the address fields. In the described solution the cells carrying a label in which VPI=10, VCI=2 are switched to the LMGW element without changing the address fields.

The following table shows a possible ATM switching configuration that can be used in the IBTS element, for example:

TABLE 3

| Input gate | input (VPI, VCI) | output gate | output (VPI, VCI) |
|---|---|---|---|
| LBTS − | (10. 2) | IBTS − LMGW | (10, 2) |
| IBTS | | | |
| LMGW − | (9,3) | IBTS − LBTS | (9, 3) |
| IBTS | | | |

In a circuit-switched network, the label values, i.e. the VPI and VCI values, do not change in the intermediate switches possibly located in the IBTS element, for example. A further characteristic of the disclosed packet network is that the values can be derived from the IP host addresses. Since the label values do not change, they can be used for unambiguously indicating different points in the subnetwork.

The packet network 150 of FIG. 1 is arranged to carry out one-to-one mapping between the subnetwork IP address and the subnetwork label values. The sender of the packet may thus always replace the destination IP address with a label, or add the label to the destination IP address. Between the source and the destination there are so-called intermediate nodes, which may form an ATM switching table on the basis of the IP transfer table.

The ATM switching configuration shown in table 3 is obtained using the information provided by the transfer table 2. More precisely, the VPI/VCI identifiers in table 2 are formed of the two last octets of the IP destination addresses in table 3.

If the disclosed packet network is for example an ATM network, MPLS switching may be freely used in the network and thus label values may be freely selected. This means that there is another table for the mapping, the table being applied between the IP subnetworks and the labels. In other words, at least two freely selectable values can be used in the label.

Between the IP header field and the layer 2 label there must be one-to-one correspondence, which in this case means a mathematical bijection. A characteristic of a bijection is that a function has an inverse function, which allows the function's original value to be calculated. This mathematical method is used to be able to reconstruct the IP address part used for forming the layer 2 label from a corresponding label in an unambiguous manner.

Table 4 below illustrates the relationship between the IP header and the channel identifier. Table 4 assumes that the invention is implemented using the eight least important bits (the host address) and the DSCP field included in the destination address given in the IP header. It is further assumed that ATM virtual channels are in use in layer 2. As shown by table 4, the IP address and the channel identifier are presented as specific number pairs. A first number pair comprises the IP address and the DSCP field of the destination and a second number pair comprises the VPI/VCI identifiers.

TABLE 4

| Function | Value | Use |
|---|---|---|
| f(IP-host, DSCP) | (VPI, VCI) | A station sending to address (IP- |
| | | host, DSCP) sets the ATM virtual |
| | | circuit identifier. The ATM cells |
| | | are switched through ATM |
| | | switches located between the cells |
| | | and given to the IP layer only at |
| | | the end part of the connection. |
| f¹(VPI, VCI) | (IP-host, DSCP) | The station receiving from the |
| | | ATM virtual circuit deducts the |
| | | values of the IP-host and DSCP |
| | | fields directly from the channel |
| | | identifier. The values can be re- |
| | | moved from the IP header by com- |
| | | pression. |

The setting of the ATM virtual circuit means that an IP datagram, i.e. an IP packet, is segmented into ATM cells and the VPI/VCI identifiers are set as identifiers for the virtual channel of the cell headers. The ATM switch referred to in table 4 may be located in the IBTS, for example, and it is used for the switching of cells between the LMGW and the LBTS.

In addition to the description relating to the IP header and the channel identifier, it is required that the link layer does not reserve channel identifiers based on the IP header from all of its network connections. For example, the ATM switch may transmit a VC (Virtual Channel) cell of a channel arriving through a gate. A cell received over the transmission path is thus assumed to carry a specific channel identifier. In ordinary ATM switching, however, the value of the channel identifier changes, but in the method of the invention the ATM switch is configured such that the identifier does not necessarily change. Instead, in an embodiment of the invention, the output gate is required to use the same channel identifier as well. In other words, in that case the VPI/VCI identifiers remain unchanged when the packet travels through the switch.

Although the invention is described above with reference to an example according to the accompanying drawings, it is apparent that the invention is not restricted to it, but may vary in many ways within the inventive idea disclosed in the claims.

1. A method for transmitting a packet from a source to a destination on the basis of an IP header in a packet network employing an IP protocol, comprising:
dropping at least a part of the IP header to a lower protocol layer; and
transmitting the packet to the destination on the basis of the dropped part.

2. A method for transmitting a packet from a source to a destination on the basis of an IP header in a packet network employing an IP protocol, the IP header comprising a destination address from which a host part is dropped to a lower protocol layer, the method comprising:
forming a label from the host part of the destination address to label the packet; and
transferring the packet to the destination indicated by the label.

3. A method according to claim 1, wherein the header comprises a destination address from which least significant bits are dropped to the lower protocol layer for forming a channel identifier for the packet to be transmitted.

4. A method according to claim 2, wherein least significant bits are dropped from the destination address to the lower protocol layer for forming a channel identifier for the packet to be transmitted.

5. A method according to claim 1, wherein the header comprises a destination address from which 16 least significant bits are dropped to the lower protocol layer for forming a channel identifier for the packet to be transmitted.

6. A method according to claim 2, wherein 16 least significant bits are dropped from the destination address to the lower protocol layer for forming a channel identifier for the packet to be transmitted.

7. A method according to claim 1, wherein the header comprises a destination address from which least significant bits are dropped to the lower protocol layer and the dropped bits are used for forming VPI/VCI identifiers for an ATM subnetwork.

8. A method according to claim 2, wherein least significant bits are dropped from the destination address to the lower protocol layer and the dropped bits are used for forming VPI/VCI identifiers for an ATM subnetwork.

9. A method according to claim 2, wherein the packet is transferred to the destination address on a channel identified on the basis of the label.

10. A method according to claim 2, wherein virtual circuits are formed in the lower layer on the basis of the packet's routing information for transmitting the packet to the destination indicated by the label.

11. A method according to claim 1, wherein least significant bits are dropped from the destination address to the lower protocol layer to serve as the destination address.

12. A method according to claim 2, wherein least significant bits are dropped from the destination address to the lower protocol layer to serve as the destination address.

13. A method according to claim 2, wherein 16 least significant bits are dropped from the destination address to the lower protocol layer and the dropped bits are used for forming a label.

14. A method according to claim 1, wherein the dropped address part is used for forming VPI/VCI identifiers for an ATM subnetwork.

15. A method according to claim 2, wherein the dropped address part is used for forming VPI/VCI identifiers for an ATM subnetwork.

16. A method according to claim 1, wherein the destination address comprises a host part which is dropped from IP protocol layer three to layer two.

17. A method according to claim 2, wherein the destination address comprises a host part which is dropped from IP protocol layer three to layer two.

18. A method according to claim 1, wherein the packet is transmitted to the destination on the basis of the destination address given in the destination address field of the IP header, part of the destination address being dropped to a lower protocol layer.

19. A method according to claim 2, wherein the packet is transmitted to the destination on the basis of the destination address given in the destination address field of the IP header, part of the destination address being dropped to a lower protocol layer.

20. A packet network applying an IP protocol for transmitting a packet from a source to a destination on the basis of an IP header, wherein the packet network comprises:
a first means arranged to drop at least a part of the destination address included in the IP header to a lower protocol layer to serve as a label; and
a second means arranged to transmit the packet to the destination indicated by the label.

21. A packet network applying an IP protocol for transmitting a packet from a source to a destination on the basis of an IP header, wherein the packet network comprises
a first means arranged to drop at least a part of the destination address included in the IP header to a lower protocol layer;
a third means arranged to form a label from the host part of the destination address for labelling the packet; and
a second means arranged to transmit the packet to the destination indicated by the label.

22. A packet network according to claim 20, wherein the label is the channel identifier of said lower protocol layer and it is arranged to identify the transmission channel to be used in the transfer of the packet.

23. A packet network according to claim 21, wherein the label is the channel identifier of said lower protocol layer and it is arranged to identify the transmission channel to be used in the transfer of the packet.

24. A packet network according to claim 20, wherein the second means is arranged to form virtual circuits in the lower layer on the basis of the packet's routing information for transmitting the packet to the destination indicated by the label.

25. A packet network according to claim 21, wherein the second means is arranged to form virtual circuits in the lower layer on the basis of the packet's routing information for transmitting the packet to the destination indicated by the label.

26. A packet network according to claim 20, wherein the first means is arranged to drop least significant bits of the address field to the lower protocol layer.

27. A packet network according to claim 21, wherein the first means is arranged to drop least significant bits of the address field to the lower protocol layer.

28. A packet network according to claim 20, wherein the first means is arranged to drop least significant bits of the address field to the lower protocol layer.

29. A packet network according to claim 21, wherein the first means is arranged to drop least significant bits of the address field to the lower protocol layer.

30. A packet network according to claim 20, wherein the first means is arranged to drop least significant bits of the address field to the lower protocol layer and to form a label from the dropped bits.

31. A packet network according to claim 21, wherein the first means is arranged to drop least significant bits of the address field to the lower protocol layer and to form a label from the dropped bits.

32. A packet network according to claim 20, wherein the packet network is implemented using ATM technology and the third means is arranged to form VPI/VCI identifiers for the ATM subnetwork from the address dropped by the first means.

33. A packet network according to claim 21, wherein the packet network is implemented using ATM technology and the third means is arranged to form VPI/VCI identifiers for the ATM subnetwork from the address dropped by the first means.

34. A packet network according to claim 20, wherein the label comprises two freely selectable values.

35. A packet network according to claim 21, wherein the label comprises two freely selectable values.

36. A packet network according to claim 20, wherein the IP header is an additional header field.

37. A packet network according to claim 21, wherein the IP header is an additional header field.

38. A packet network according to claim 20, wherein the first means is arranged to drop the host address from the IP protocol layer three to layer two.

39. A packet network according to claim 21, wherein the first means is arranged to drop the host address from the IP protocol layer three to layer two.
